(19) United States
(12) Patent Application Publication
(10) Pub. No.: US 2024/0209841 A1
(43) Pub. Date: Jun. 27, 2024

(54) METHOD AND DEVICE FOR DETERMINING AN ICED CONDITION OF A WIND TURBINE BLADE

(71) Applicant: Siemens Gamesa Renewable Energy Innovation & Technology S.L., Sarriguren (Navarra) (ES)

(72) Inventors: Esteban Belmonte de Udaondo, Pamplona (ES); Jorge Elso Torralba, Pamplona (ES); Irene Miquelez Madariaga, Pamplona (ES); Aitor Saenz Aguirre, Oñati, Guipuzkoa (ES); Pablo Vital Amuchastegui, Pamplona (ES)

(21) Appl. No.: 18/556,530

(22) PCT Filed: Apr. 7, 2022
(86) PCT No.: PCT/EP2022/059328

§ 371 Date: Oct. 20, 2023

(30) Foreign Application Priority Data
Apr. 28, 2021 (EP) 21382369.3

(51) Int. Cl. F03D 80/40; G01P 15/00

(52) U.S. Cl. CPC F03D 80/405; G01P 15/00

(57) ABSTRACT

A method and a device for determining an iced condition of a blade of a wind turbine is provided. A target nacelle displacement along a rotational axis is acquired as a function of at least one predetermined parameter in an ice-free condition of the blade; an actual nacelle displacement along the rotational axis is measured by a displacement sensor; and the iced condition of the blade is determined if a difference between the target nacelle displacement and the actual nacelle displacement exceeds a predetermined threshold value.

### CROSS-REFERENCE TO RELATED APPLICATIONS

This application claims priority to PCT Application No. PCT/EP2022/059328, having a filing date of Apr. 7, 2022, which claims priority to EP Application No. 21382369.3, having a filing date of Apr. 28, 2021, the entire contents both of which are hereby incorporated by reference.

### FIELD OF TECHNOLOGY

The following relates to a method and a device for determining an iced condition of a blade of a wind turbine. Ice accretion on wind turbine blades causes power losses as well as an unexpected increase on mechanical loads, which reduces the lifespan of the wind turbine.

### BACKGROUND

There exist several conventional methods for ice detection, based on the different effects of ice accretion on the wind turbine and its operation. U.S. Pat. No. 7,086,834 B1 describes an increase on a mass of blades, which in turn changes their natural frequencies. EP 2 561 221 A1 describes changes on a power curve. U.S. Pat. No. 2012 207 589 A1 describes changes on a surface of the blades, which are detected by changes in the reflecting properties of the surface of the blade. CN 104 180 980 B1 describes changes in aerodynamic properties which are observed in the wind stream.

### SUMMARY

There may be a need for a method and a device for determining an iced condition of a blade of a wind turbine, which are robust, cost competitive and easy to implement.

According to a first aspect of embodiments of the invention, a method of determining an iced condition of a blade of a wind turbine is provided. The wind turbine comprises a nacelle and a hub, the hub having the blade and being mounted to the nacelle rotatably about a rotation axis. The method comprises steps of: acquiring a target nacelle displacement along the rotational axis as a function of at least one predetermined parameter in an ice-free condition of the blade; determining an actual nacelle displacement along the rotational axis by means of a displacement sensor; calculating a difference between the target nacelle displacement at an actual value of the at least one predetermined parameter and the actual nacelle displacement; and determining the iced condition of the blade if the difference between the target nacelle displacement and the actual nacelle displacement exceeds a predetermined threshold value.

In an embodiment, the at least one predetermined parameter is selected from a group comprising a power coefficient of the wind turbine, a thrust coefficient of the wind turbine, a pitch angle of the blade, a tip speed ratio of the wind turbine, and a power generated by a generator of the wind turbine.

The power coefficient Cp can be expressed as

$${C}_{P} = \frac{P}{\frac{1}{2} ρ {AV}^{3}} ,$$

wherein P is a power generated by the generator, ρ is an air density, A is an area spanned by the rotating blade, and V is a wind speed.

The thrust coefficient Ct can be expressed as

$${C}_{T} = \frac{T}{\frac{1}{2} ρ {AV}^{2}}$$

wherein T is a thrust acting on the nacelle.

The tip speed ratio is a ratio between a tangential speed of a tip of the blade and the wind speed V.

In an embodiment, the displacement sensor is an accelerometer installed in the nacelle, which accelerometer measures an acceleration of the nacelle, and the actual nacelle displacement is determined based on the measured acceleration. In an embodiment, the actual nacelle displacement is determined by filtering the acceleration from the accelerometer. In an embodiment, the accelerometer senses a gravity change due to an inclination of the nacelle, when the nacelle is displaced along the rotational axis, wherein the actual nacelle displacement is calculated based on the sensed gravity change.

In an embodiment, the iced condition of the blade is determined if an error parameter DXₑᵣᵣₒᵣ exceeds the predetermined threshold value, with

$${DX}_{error} = \frac{{DX}_{FILT} - {DX}_{TABLE}}{{DX}_{FILT}} ,$$

wherein DX_{FILT} is the actual nacelle displacement and DX_{TABLE} is the target nacelle displacement.

In an embodiment, the target nacelle displacement in relation to the actual value of the at least one predetermined parameter is stored in a look-up table.

According to a second aspect of embodiments of the invention, a device for determining an iced condition of a blade of a wind turbine is provided. The wind turbine comprises a nacelle and a hub, the hub having the blade and being mounted to the nacelle rotatably about a rotation axis. The device comprises an acquiring unit configured to acquire a target nacelle displacement along the rotational axis as a function of at least one predetermined parameter in an ice-free condition of the blade; a first determining unit configured to determine an actual nacelle displacement along the rotational axis by a displacement sensor; a calculating unit configured to calculate a difference between the target nacelle displacement at an actual value of the at least one predetermined parameter and the actual nacelle displacement; and a second determining unit configured to determine the iced condition of the blade if the difference between the target nacelle displacement and the actual nacelle displacement exceeds a predetermined threshold value.

In an embodiment, the at least one predetermined parameter is selected from a group comprising a power coefficient of the wind turbine, a thrust coefficient of the wind turbine, a pitch angle of the blade, a tip speed ratio of the wind turbine, and a power generated by a generator of the wind turbine.

In an embodiment, the displacement sensor is an accelerometer installed in the nacelle, which accelerometer measures an acceleration of the nacelle, and the first determining unit is configured to determine the actual nacelle displacement based on the measured acceleration. In an embodiment, the first determining unit is configured to determine the actual nacelle displacement by filtering the acceleration from the accelerometer. In an embodiment, the accelerometer is configured to sense a gravity change due to an inclination of the nacelle, when the nacelle is displaced along the rotational axis, wherein the first determining unit is configured to determine the actual nacelle displacement based on the sensed gravity change.

In an embodiment, the second determining unit is configured to determine the iced condition of the blade if an error parameter DXₑᵣᵣₒᵣ exceeds the predetermined threshold value, with

$${DX}_{error} = \frac{{DX}_{FILT} - {DX}_{TABLE}}{{DX}_{FILT}} ,$$

wherein DX_{FILT} is the actual nacelle displacement and DX_{TABLE} is the target nacelle displacement.

In an embodiment, the device further comprises a storing unit storing the target nacelle displacement in relation to the actual value of the at least one predetermined parameter in a look-up table.

Advantageously, embodiments of the present invention does not require the knowledge of the wind speed, which is usually difficult to measure and not very reliable. Embodiments of the present invention do not require to install or calibrate any sensor which is usually not included in a wind turbine, thereby being robust, cost competitive and easy to implement. The signal treatment tools used by embodiments of the present invention are standard blocks already used for control purposes. The ice accretion can be detected during the operation of the wind turbine. The detection of the presence of ice on the blades allows to start de-icing mechanisms or to stop the operation of the turbine on time. Thereby, unnecessary loads are avoided, and normal power production levels can be sustained.

### BRIEF DESCRIPTION

Some of the embodiments will be described in detail, with reference to the following figures, wherein like designations denote like members, wherein:

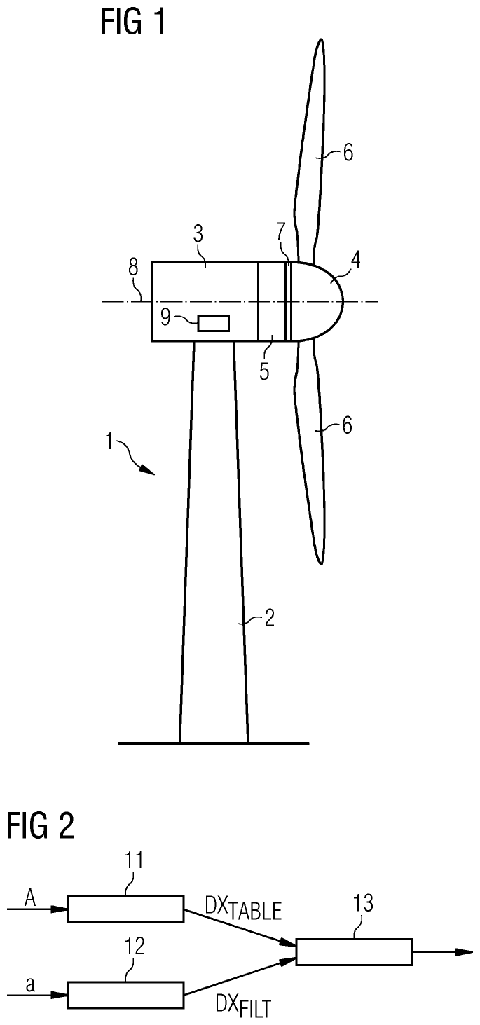

FIG. 1 shows a wind turbine and the different elements thereof; and

FIG. 2 shows a block diagram of a method of determining an iced condition of a blade of a wind turbine according to an embodiment.

### DETAILED DESCRIPTION

The illustrations in the drawings are schematically. It is noted that in different figures, similar or identical elements are provided with the same reference signs.

FIG. 1 shows a wind turbine 1. The wind turbine 1 comprises a nacelle 3 and a tower 2. The nacelle 3 is mounted at the top of the tower 2. The nacelle 3 is mounted rotatable with regard to the tower 2 by means of a yaw bearing. The axis of rotation of the nacelle 3 with regard to the tower 2 is referred to as the yaw axis.

The wind turbine 1 also comprises a hub 4 with three rotor blades 6 (of which two rotor blades 6 are depicted in FIG. 1). The hub 4 is mounted rotatable with regard to the nacelle 3 by means of a main bearing 7. The hub 4 is mounted rotatable about a rotor axis of rotation 8.

The wind turbine 1 furthermore comprises a generator 5. The generator 5 in turn comprises a rotor connecting the generator 5 with the hub 4. If the hub 4 is connected directly to the generator 5, the wind turbine 1 is referred to as a gearless, direct-driven wind turbine. Such a generator 5 is referred as direct drive generator 5. As an alternative, the hub 4 may also be connected to the generator 5 via a gear box. This type of wind turbine 1 is referred to as a geared wind turbine. Embodiments of the present invention is suitable for both types of wind turbines 1.

The generator 5 is accommodated within the nacelle 3. The generator 5 is arranged and prepared for converting the rotational energy from the hub 4 into electrical energy in the shape of an AC power.

FIG. 2 shows a block diagram of a method of determining an iced condition of the blades 6 of the wind turbine 1 according to an embodiment. The method is carried out by a device (not shown), which can be a local or global control device for controlling the wind turbine 1. The device comprises an acquiring unit 11 which is configured to acquire a target nacelle displacement DX_{TABLE} along the rotational axis 8 as a function of at least one predetermined parameter A in an ice-free condition of the blades 6, and a first determining unit 12 which is configured to determine an actual nacelle displacement DX_{FILT} along the rotational axis 8 by a displacement sensor 9. The device further comprises a calculating unit 13 which is configured to calculate a difference between the target nacelle displacement DX_{TABLE} at an actual value of the at least one predetermined parameter A and the actual nacelle displacement DX_{FILT}, and a second determining unit 13 which is configured to determine the iced condition of the blade 6 if the difference between the target nacelle displacement DX_{TABLE} and the actual nacelle displacement DX_{FILT} exceeds a predetermined threshold value. In the present embodiment, the calculating unit 13 and the second determining unit 13 are depicted in the same block for simplification.

The above-mentioned algorithm solves the ice detection problem by comparing two values DX_{TABLE} and DX_{FILT}, which should be similar under normal, ice-free operation conditions and which differ under the iced condition of the blades 6. The first value is the estimated, actual nacelle displacement DX_{FILT} along the rotation axis 8, which can be obtained from a raw nacelle acceleration measurement. The second signal is the expected, target nacelle displacement DX_{TABLE} along the rotation axis 8 under normal operation conditions, which can be obtained in advance from power and pitch signals, for example.

The at least one predetermined parameter A can be selected from a group comprising a power coefficient Cp of the wind turbine 1, a thrust coefficient Ct of the wind turbine 1, a pitch angle of the blade 6, a tip speed ratio λ of the wind turbine 1, and a power P generated by the generator 5 of the wind turbine 1.

The power coefficient Cp can be expressed as

$${C}_{P} = \frac{P}{\frac{1}{2} ρ {AV}^{3}} ,$$

wherein P is the power generated by the generator 5, ρ is an air density, A is an area spanned by the rotating blades 6, and V is a wind speed.

The thrust coefficient Ct can be expressed as

$${C}_{T} = \frac{T}{\frac{1}{2} ρ {AV}^{2}} ,$$

wherein T is a thrust acting on the nacelle 3.

The tip speed ratio λ is a ratio between a tangential speed of a tip of the blades 6 and the wind speed V.

The estimation of the expected target nacelle displacement DX_{TABLE} can be based on a univocal relation between the thrust coefficient Ct, the pitch angle and the tip speed ratio λ, which can be represented by Ct-λ-curves. In turn, the tip speed ratio λ depends on a generator speed, whose relationship with the generated power P can be determined as follows: below a rated operation power P, λ is proportional to a cube of the generator speed, and above the rated operation power P, both signals are held constant.

Similarly, a proportionality relation can be established between the thrust T acting on the nacelle 3 and the target nacelle displacement DX_{TABLE} which is caused by the thrust T.

All in all, normal operation simulation data can be fitted into a surface which can be represented by a two-dimensional polynomial of second order, in which the pitch angle and the power P are the independent variables and the target nacelle displacement DX_{TABLE} is the dependent variable. The polynomial reflects the expected target nacelle displacement DX_{TABLE} in absence of ice because the used data correspond to the operation under normal conditions for a given pair of pitch angles and power values P.

However, the ice accretion on the blades 6 changes the aerodynamic behaviour of the wind turbine 1. This means that in presence of ice, the relation between the pitch angle, the power P and the thrust T will no longer be equal to that one described by the theoretical Ct-lambda curves or the two-dimensional polynomial. In other words, the target nacelle displacement DX_{TABLE} returned by the polynomial will differ from the actual nacelle displacement DX_{FILT}, for example from that value which is a value provided by a filter of the displacement sensor 9.

In the embodiment of FIG. 1, the displacement sensor 9 is an accelerometer installed in the nacelle 3, which accelerometer 9 measures an acceleration a of the nacelle 3. The first determining unit 13 can be configured to determine the actual nacelle displacement DX_{FILT} by filtering the acceleration a from the accelerometer 9. In particular, the accelerometer 9 can be configured to sense a gravity change due to an inclination of the nacelle 3, when the nacelle 3 is displaced along the rotational axis 8, wherein the first determining unit 13 is configured to determine the actual nacelle displacement DX_{FILT} based on the sensed gravity change.

The calculation of the actual nacelle displacement DX_{FILT} can be performed by using the signal provided by the accelerometer 9 installed in the nacelle 3. A filtering process can be applied to the acceleration a. Due to the inclination of the nacelle 3 in the fore-aft movement, the accelerometer 9 can capture the gravity contribution which is essential for the calculation.

Because the relation between the acceleration a and the actual nacelle displacement DX_{FILT} is not affected by external conditions, the actual nacelle displacement DX_{FILT} provided by the filter is close to the real one with independence from the presence of ice.

The second determining unit 13 can be configured to determine the iced condition of the blade 6 if an error parameter DXₑᵣᵣₒᵣ exceeds the predetermined threshold value, with

$${DX}_{error} = \frac{{DX}_{FILT} - {DX}_{TABLE}}{{DX}_{FILT}} ,$$

wherein DX_{FILT} is the actual nacelle displacement and DX_{TABLE} is the target nacelle displacement. The error threshold parameter DXₑᵣᵣₒᵣ determines the detection of ice and can be chosen based on simulation results.

The device according can further comprise a storing unit storing the target nacelle displacement DX_{TABLE} in relation to the actual value of the at least one predetermined parameter A in a look-up table.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of determining an iced condition of a blade of a wind turbine, the wind turbine comprising a nacelle and a hub, the hub having the blade and being mounted to the nacelle rotatably about a rotational axis, the method comprising:
acquiring a target nacelle displacement along the rotational axis as a function of at least one predetermined parameter in an ice-free condition of the blade;
determining an actual nacelle displacement along the rotational axis by means of a displacement sensor;
calculating a difference between the target nacelle displacement at an actual value of the at least one predetermined parameter and the actual nacelle displacement; and
determining the iced condition of the blade if the difference between the target nacelle displacement and the actual nacelle displacement exceeds a predetermined threshold value.

2. The method according to claim 1, wherein the at least one predetermined parameter is selected from a group comprising a power coefficient of the wind turbine, a thrust coefficient of the wind turbine, a pitch angle of the blade, a tip speed ratio of the wind turbine, and a power generated by a generator of the wind turbine.

3. The method according to any claim 1, wherein the displacement sensor is an accelerometer installed in the nacelle, which accelerometer measures an acceleration of the nacelle, and the actual nacelle displacement is determined based on the measured acceleration.

4. The method according to claim 3, wherein the actual nacelle displacement is determined by filtering the acceleration from the accelerometer.

5. The method according to claim 4, wherein the accelerometer senses a gravity change due to an inclination of the nacelle, when the nacelle is displaced along the rotational axis, wherein the actual nacelle displacement is determined based on the sensed gravity change.

6. The method according to claim 1, wherein the iced condition of the blade is determined if an error parameter DXₑᵣᵣₒᵣ exceeds the predetermined threshold value, with
$${DX}_{error} = \frac{{DX}_{FILT} - {DX}_{TABLE}}{{DX}_{FILT}} ,$$
wherein DX_{FILT} is the actual nacelle displacement and DX_{TABLE} is the target nacelle displacement.

7. The method according to claim 1, wherein the target nacelle displacement in relation to the actual value of the at least one predetermined parameter is stored in a look-up table.

8. A device for determining an iced condition of a blade of a wind turbine, the wind turbine comprising a nacelle and a hub, the hub having the blade and being mounted to the nacelle rotatably about a rotational axis, the device comprising:
an acquiring unit configured to acquire a target nacelle displacement along the rotational axis as a function of at least one predetermined parameter in an ice-free condition of the blade;
a first determining unit configured to determine an actual nacelle displacement along the rotational axis by a displacement sensor;
a calculating unit configured to calculate a difference between the target nacelle displacement at an actual value of the at least one predetermined parameter and the actual nacelle displacement; and
a second determining unit configured to determine the iced condition of the blade if the difference between the target nacelle displacement and the actual nacelle displacement exceeds a predetermined threshold value.

9. The device according to claim 1, wherein the at least one predetermined parameter is selected from a group comprising a power coefficient of the wind turbine, a thrust coefficient of the wind turbine, a pitch angle of the blade, a tip speed ratio of the wind turbine, and a power generated by a generator of the wind turbine.

10. The device according to claim 8, wherein the displacement sensor is an accelerometer installed in the nacelle, which accelerometer measures an acceleration of the nacelle, and the first determining unit is configured to determine the actual nacelle displacement based on the measured acceleration.

11. The device according to claim 10, wherein the first determining unit is configured to determine the actual nacelle displacement by filtering the acceleration from the accelerometer.

12. The device according to claim 11, wherein the accelerometer is configured to sense a gravity change due to an inclination of the nacelle, when the nacelle is displaced along the rotational axis, wherein the first determining unit is configured to determine the actual nacelle displacement based on the sensed gravity change.

13. The device according to claim 8, wherein the second determining unit is configured to determine the iced condition of the blade if an error parameter DXₑᵣᵣₒᵣ exceeds the predetermined threshold value, with
$${DX}_{error} = \frac{{DX}_{FILT} - {DX}_{TABLE}}{{DX}_{FILT}} ,$$
wherein DX_{FILT} is the actual nacelle displacement and DX_{TABLE} is the target nacelle displacement.

14. The device according to claim 8, further comprising:
a storing unit storing the target nacelle displacement in relation to the actual value of the at least one predetermined parameter in a look-up table.
